(19) United States
(12) Patent Application Publication
(10) Pub. No.: US 2013/0006809 A1
(43) Pub. Date: Jan. 3, 2013

(54) METHOD AND SYSTEM FOR PROVIDING A CERTIFIED SWAP PRICE FOR A VEHICLE

(75) Inventors: Robert HOLLENSHEAD, Exton, PA (US); Theodore Reimel, Wayne, PA (US)

(73) Assignee: BuyBook Technologies, Inc., Manheim, PA (US)

(21) Appl. No.: 13/175,231

(22) Filed: Jul. 1, 2011

(51) Int. Cl. G06Q 30/00

(52) U.S. Cl. 705/26.41

(57) ABSTRACT

Methods and systems are provided that swap certified pre-owned vehicles between dealers. One exemplary computer-implemented method for swapping CPO vehicles includes receiving, by a swap facilitating computer, a request to swap a first CPO vehicle for another CPO vehicle; and determining, by the swap facilitating computer using stored market values, a first base price of the first CPO vehicle and displaying available CPO vehicles or permitting inputting of identification for the other CPO vehicle having a second base price. The exemplary method further includes facilitating an offer to swap the first CPO vehicle for the other CPO vehicle by establishing base prices for each of the CPO vehicles, wherein the base prices can be first and second guaranteed prices.

### FIELD

The present disclosure relates to vehicles and, more particularly, to methods and systems for providing guarantees for selling or swapping Certified Pre-Owned (CPO) vehicles.

### BACKGROUND

Automobile dealers offer three types of vehicles for sale—“new,” “used” and “certified pre-owned” or (CPO) (“certified used”). Certified pre-owned vehicles differ from used vehicles in that a dealer certifies that they have been refurbished and tested to satisfy a standard condition level established by a manufacturer or other certification organization. The standard condition level may include, for example, certification of: the vehicle's history, the vehicle's exterior, and the vehicle's interior, and passing of road; underbody, underhood and diagnostic tests, among others. The CPO vehicles are generally less than a few years old and have low mileage (e.g., less than 60,000 miles). The CPO vehicles are also typically sold with an extended warranty, special financing or other benefits. Consequently, the CPO vehicles may be priced at a premium that offers dealers a higher profit margin.

### SUMMARY

Exemplary embodiments disclosed herein provide methods and computer implemented systems for swapping certified pre-owned vehicles between dealers at base prices set and in certain embodiments guaranteed by an appraiser.

One exemplary computer-implemented method for swapping CPO vehicles includes receiving, by an appraiser computer, a request to swap a first CPO vehicle for another CPO vehicle; and determining, by the swap facilitating computer using stored market values, a first base price of the first CPO vehicle and displaying available CPO vehicles or permitting inputting of identification for the other CPO vehicle having a second base price. The exemplary method further includes facilitating an offer to swap the first CPO vehicle for the other CPO vehicle by establishing base prices for each of the CPO vehicles, and in certain embodiments using first and second guaranteed prices as the base prices.

One exemplary computer-implemented method for swapping CPO vehicles includes receiving, by an appraiser computer, a request to swap a first CPO vehicle for a second CPO vehicle; determining, by the appraiser computer using stored market values, a first base price of the first CPO vehicle in accordance with the location of the second CPO vehicle and a second base price of the second CPO vehicle in accordance with the location of the first CPO vehicle; and providing an offer to swap the first CPO vehicle for the second CPO vehicle at the first and second base prices. The exemplary method further includes establishing, by an appraiser computer, a payment of a difference in the first and second base prices.

Some exemplary embodiments include receiving a request from a first dealer to swap a first CPO vehicle of a first dealer for a second CPO vehicle of a second dealer, determining base prices for the vehicles, providing an offer to the second dealer to swap the first CPO for the second CPO vehicle at the guaranteed prices, and paying the difference in the guaranteed prices to one of the dealers. The certification provides some certainty in purchasing or swapping vehicles prior to a buyers inspection, and to the degree the buyer's expectations are not met (e.g., the certification is inappropriate), the method and system can provide a recourse to the buyer.

One exemplary system for swapping CPO vehicles between first and second dealers includes a database of market values; an appraiser computer including a processor and a data storage device, the data storage device storing instructions that, when executed by the processor, control the appraiser computer to: (1) receive a request from the first dealer to swap a first CPO vehicle for a second CPO vehicle of the second dealer; (2) determine using the database of market values corresponding to a market of the second dealer, a first base price for the first CPO vehicle; (3) determine using the database of market values corresponding to a market of the first dealer, a second base price for the second CPO vehicle; (4) provide an offer to the second dealer to swap the first CPO vehicle for the second CPO vehicle at the base prices; and (5) pay a difference in the base prices to one of the dealers. The dealers certify that the respective vehicles have been refurbished and tested to satisfy a standard condition level established by a certification organization. The base prices may be guaranteed prices, and the guarantee may be provided by a third party appraiser, in certain embodiments.

### BRIEF DESCRIPTION OF THE DRAWINGS

Exemplary embodiments are best understood from the following detailed description when read in conjunction with the accompanying drawings. It is emphasized that, according to common practice, the various features of the drawings are not to scale and may not be in a particular order or arrangement. Included in the drawings are the following figures:

FIG. 1 is a block diagram illustrating an exemplary system for providing base prices, and even price guarantees, in accordance with various exemplary embodiments;

FIG. 2 is a block diagram illustrating an exemplary appraiser computer;

FIG. 3 is a flow chart illustrating exemplary steps for swapping vehicles performed by the appraiser computer;

FIG. 4 is a flow chart illustrating exemplary steps for determining guaranteed prices of the vehicles; and

FIG. 5 is a flow chart illustrating exemplary steps for facilitating an offer to swap the vehicles.

### DETAILED DESCRIPTION

After investing in a used vehicle to certify it, a dealer may not be able to quickly sell the vehicle. Indeed, a CPO vehicle's higher price can make it more difficult to sell, especially compared to similar late-model vehicles offered by private-parties. Due to expenses associated with keeping an inventory of vehicles and the fact that vehicles are “wasting” assets that depreciate in value fairly quickly, the longer the vehicle goes unsold, the lower a dealer's profit margin will become until, eventually, the dealer may sell the vehicle at a wholesale market for little or no profit or, even a loss. There are other factors that reduce the chance of a dealer selling a particular car if not sold quickly, and statistically the longer a car remains in inventory, the less likely it will be sold in a retail setting. The present inventors observe that old inventory is a major cause of failures of dealerships. Simply selling the old inventory to a new dealer can increase the chance of its sale, even if that dealership is in the same or similar market.

To maximize its profits, the dealer may sell the vehicle to another dealer in the same or a different market (e.g., in another geographic region or another market defined by any conventional means including but not limited to the target consumers' community demographics, climate zone, etc.) where demand for the vehicle is higher. The dealer, however, may have few contacts with dealers, particularly in other markets. Thus, the number of other dealers that might be offered the vehicle may be limited. Further, the dealer may have little or no insight into the current demand for a particular vehicle in other markets. Moreover, the dealer buying the vehicle may take a risk that the vehicle must undergo additional refurbishing and recertification either because of errors in the previous certification or to meet higher standards in the buyers market, for example. As such, the selling dealer may not obtain the best price for the vehicle.

The CPO vehicles often represent a heightened investment by dealers. Market conditions for a particular vehicle, however, may be better in another market. For example, demand for a convertible may be stronger in Dallas, Tex. than in Pittsburgh, Pa. On the other hand, demand for an all-wheel drive station wagon may be stronger in Pittsburgh, Pa. than in Dallas, Tex. Likewise, a premium vehicle may be in greater demand in an affluent neighborhood than in a less affluent neighborhood, the reverse for standard (non-premium) vehicles. Accordingly, a dealer may maximize return on his investment in the CPO vehicles by swapping the CPO vehicles with another dealer in a different market.

One of the non-limiting aspects of the present invention is providing a price guarantee by a third party for CPO vehicles. The price guarantee might be backed by the third party promising to buy the vehicle at the set price, makeup the difference or provide other considerations. By providing the price guarantee, the two dealers wishing to swap vehicles are only at risk for the difference between their prices for the respective vehicles and the guaranteed price. For example, if dealer A believes car X is worth $12,000 and has a guaranteed price from a third party of $10,000 acting as a first base price, and dealer B believes car Y is worth $22,000 with a price guarantee of $20,000, which acts as a second base price, each dealer is at risk for only $2,000. These price guarantees greatly facilitate the willingness of each dealer to make the transaction.

In fact, it is entirely possible that the two dealers do not receive and indication of the amount of the base prices, but rather just the difference between them. This can facilitate the swap insofar as any loss or gain may not have to be recognized at the time of the swap.

In certain embodiments the base prices are guaranteed, but it may be sufficient for the base prices to come from an reliable source such as BuyBook™ rather than a formal price guarantee.

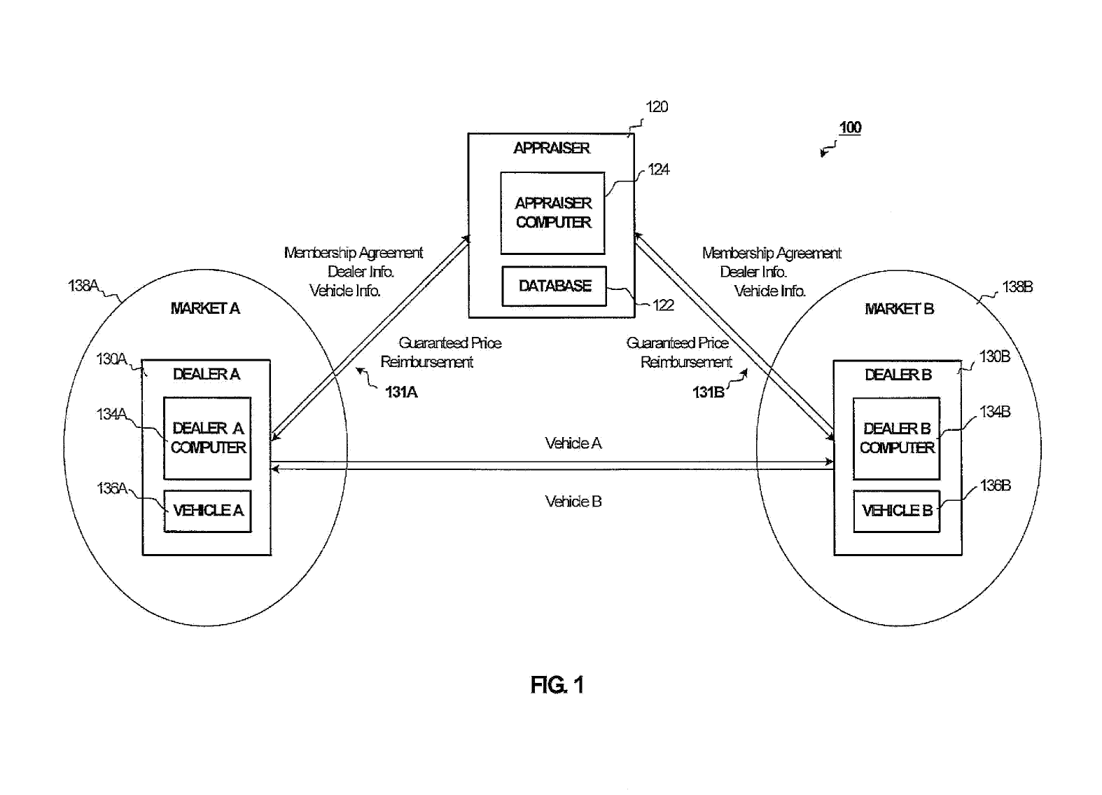

FIG. 1 is a block diagram illustrating an exemplary system 100 for providing price guarantees for vehicles (e.g., CPO vehicles) in accordance with various exemplary embodiments. Details of how the guarantee process works can be found in U.S. patent application Ser. No. 12/829,442 entitled “METHOD AND SYSTEM FOR PROVIDING A GUARANTEED OFFER PRICE FOR A VEHICLE” naming Robert Hollenshead and Theodore Reimel as inventors, herein incorporated by reference.

Referring to FIG. 1, the exemplary system 100 may include an appraiser system 120 and first and second dealer systems 130A and 130B (collectively, the dealer systems 130). Here, appraiser and dealer systems refer to computer systems that include specifically programmed processes, databases, tangible memory devices and possibly servers, routers and other physical equipment that are used to support the sale and appraisal of vehicles. “Systems” does not encompass purely human interactions. The first and second dealer systems 130A and 130B may sell vehicles 136A and 136B to consumers and/or sell or swap vehicles 136A and 136B to other dealer systems. The first dealer system 130A may include a first dealer computer 134A, may possess (or own or hold title to) the vehicle 136A. The second dealer system 130B may include a second dealer computer 134B, and may possess (or own or hold title to) the vehicle 136B.

The dealer systems 130 may each register for and establish a membership agreement with the appraiser system 120. In certain exemplary embodiments, the membership agreement may be established online via the Internet or other private two-way network connection 131A and 131B. The membership agreement may have the appraiser system 120 guarantee prices of vehicles determined for the dealer systems 130 by the appraiser computer 124. In addition, the membership agreement may have the dealer systems 130 pay the appraiser system 120 a fee (e.g., a one-time fee, a periodic fee, per use fees, seat licenses, and/or other fees or fee structures, etc.) or other consideration to be a member of the appraiser service.

The appraiser system 120 may include the appraiser computer 124 and may be a vehicle appraisal service provided to vehicle dealers and/or consumers. The appraiser system 120 may be an individual or entity (e.g., business entity) that provides such services, either part of or separate from the appraiser system 120.

In certain exemplary embodiments, the appraiser system 120 may establish in an appraiser computer web server software that enables communication with (or exchange of information via communication links 131A and 131B using web pages sent to a browser or other software executing on the dealer computers 134A and 134B.

In certain exemplary embodiments, the web page (or information messages) may include: (1) a membership offer message (or web page) by the appraiser system 120 to the dealer systems 130. Each dealer system 130A or 130B may initiate membership in the appraiser service by providing membership information including, for example, dealer information and vehicle information. The membership information may include information for the appraiser system 120 to setup a credit, prepayment or escrow account to handle payments to each dealer system 130A or 130B and/or from each dealer system 130A or 130B.

The membership agreement may have vehicles offered to another dealer system 130 for a swap be CPO vehicles that may have been refurbished (e.g., repaired and cleaned) and inspected to a satisfy a standard condition level set by an entity other than the individual dealer, e.g., the appraiser, a manufacturer or other certifying organization.

Once the membership information is completed by the dealer system 130, it may be sent to and stored in a database (or set of tables) 122 of the appraiser system 120. The membership information may be stored in the database 122 for tracking of: (1) membership registrations including a unique membership identifier of each registered member after registration; (2) dealer information associated with the membership including financial information (e.g., credit, prepayment and/or escrow account information and/or limits, basic membership information (such as address and contact information, among other) and vehicle information associated with the CPO vehicles 136A or 136B that are available for sale or for swapping.

In certain exemplary embodiments, the database 122 may store each completed transaction (e.g., the price guarantee by the appraiser system 120). In other exemplary embodiments, the database 122 may store each inquiry by a member dealer system 130 for a potential sale or swap of a CPO vehicle 136A or 136B.

The appraiser system 120 may regularly deal in a number of different, adjacent or overlapping markets and may gather in the database 122 inventories of vehicles of member dealer systems 130. As such, the appraiser system 120 may possess information on vehicle supply, demand and/or price in a wide array of markets. By contrast, a dealer's information may be limited to its own market or even its own business. As an example, the appraiser system 120 may have greater access to the different markets 138A and 138B than a particular dealer system 130A or 130B, which may enable an accurate determination of a price for particular vehicles in the various markets.

For example, the first dealer system 130A may be in a different market relative to the second dealer system 130B. That is, the first dealer system 130A may be in a first market 138A and the second dealer may be in a second market 138B. “Market” generally refers to any channels that allow different sets of consumers (although the markets can be overlapping sets) which may interact with one or more dealer systems 130 in order to purchase a vehicle. The price of a vehicle in the different markets may be based on market forces (e.g., supply and demand, sales techniques, demographics, etc.) for the particular vehicle in each respective market. The first and second markets 138A and 138B may be distinguished by one or more of the following: different locations (e.g., a city, a metropolitan area, a state and/or a country, among others), different dealer types (e.g., a new dealer, a used dealer, a manufacturer, a franchise dealer and/or an independent dealer, among others), different business transaction types (e.g., a retail transaction, a wholesale transaction, or an auction transaction), different financial transaction types (e.g., online or offline sales, and cash or credit sales), different buyer types (e.g., an individual buyer, a business buyer, a dealer, and/or a fleet buyer, among others) or different customer demographics, or combinations of any and all of these distinguishing characteristics thereof.

The appraiser computer 124 and the first and second dealer computers 134A and 134B may be information-processing apparatus and/or systems, such as a specifically programmed general-purpose computer, a mobile computer, a server or an application-specific device (e.g., a set-top box or, or a mobile telephone, among others) that can be communicatively linked to one another. The communication links 131A and 131B between the appraiser computer 124 and the first and/or second computers 134A and 134B of the dealer systems 130 may be wired or wireless links using a variety of communication protocols. The particular composition and protocol of the communication links 131A and 131B may not be critical, as long as they allow for communication between or among the first and/or second dealer computers 134A and 134B and the appraiser computer 124.

In some exemplary embodiments, the communication links 131A and 131B can be a direct connection, such as an analog, a serial or a parallel interface. In other embodiments, the communication links 131A and 131B may be shared, public, private, or peer-to-peer networks, encompassing any wide or local area network, such as an extranet, an intranet, the Internet, a Local Area Network (LAN), a Wide Area Network (WAN), a virtual private network (VPN), a voice-over-internet packet network (VoIP), a public switched telephone network (PSTN), an Integrated Services Digital Network (ISDN), or any other form of wired or wireless communication. The communication links 131A and 131B can be compatible with any type of communication protocol used by the components of system 100 to exchange data, such as Ethernet protocol, ATM protocol, Transmission Control/Internet Protocol (TCP/IP), Hypertext Transfer Protocol (HTTP), Hypertext Transfer Protocol Secure (HTTPS) or peer-to-peer protocol.

The selling dealer system 130A desiring to swap a certified pre-owned (CPO) vehicle with another dealer, such as a buying dealer system 130B, may provide contact information and vehicle information to the appraiser computer 124 at that time to the appraiser computer 124. Alternatively, the dealer system 130A may have previously provided its contact information to the appraiser system 120 or dealer system 130A may provide this information along with the vehicle information.

The contact information may include the dealer's name, address, electronic mail address and/or telephone number. Vehicle information may include information describing the type of vehicle, the vehicle's condition and the vehicle's history. A vehicle's description information may include make, model, year, trim level, color and/or options. The condition information may include mileage, wear-and-tear and/or damage. The history information may include ownership information, maintenance information, accident information and/or insurance information.

The dealer system 130 may provide their contact information and vehicle information to the appraiser computer 124 within an online session in which an interactive interview may be conducted through a user interface provided by the appraiser computer 124 to the dealer computers 134 which prompts dealer system 130 to provide the information in a piecemeal or serial manner. For example, the interactive session may include the execution of an applet on the dealer computer 134A that may be downloaded from the appraiser computer 124 to enable the interactive session. However, the disclosed embodiments are not limited to such examples. The dealer system 130 may provide information at different times before or during an appraisal session.

In certain exemplary embodiments, the information may be provided off-line or prior to a particular swap transaction, e.g., using a paper, an electronic form or an electronic checklist from which the information may be extracted by the appraiser computer 124 and stored in the database 122 for retrieval later.

In certain exemplary embodiments, the dealer system 130 may provide information that does not change readily (such as contact information) as part of the registration process to prefill swap transaction information. The information can then be retrieved and/or updated by the dealer system 130 in a later appraisal session.

Based on the received vehicle information, the appraiser computer 124 may determine a guaranteed price for a specific vehicle 136A of the dealer system 130A. The guaranteed price may be adjusted for the market supply and/or demand for the vehicles in the particular markets of the dealer system 130B to which the vehicle will be swapped.

The guaranteed price may be determined, for example, based on other swap transaction prices of the same or similar vehicles and the inventory (e.g., supply) and recent demand for such a vehicle that may be stored in the database 122. That is, for example, the appraiser computer 124 may analyze the historical price for the vehicle, the local and/or national supply of the vehicle, and/or the long-term (above a threshold length of time) demand for the vehicle to determine the guaranteed price of the vehicle.

A reimbursement message or web page indicating a guaranteed price reimbursement for a vehicle may be sent via the communication links 131A or 131B from the appraiser computer 124 to the dealer computer 134A or 134B of the appropriate member dealer systems 130A or 130B. For example, in a swap between the dealer system 130A and 130B for vehicles 136A and 136B, the computer 134A of the dealer system 130A may be sent a first reimbursement message indicating a first guaranteed price reimbursement for the vehicle (e.g., the CPO vehicle) 136A from the appraiser computer 124 and the computer 134B of the dealer system 130B may be sent a second reimbursement message indicating a second guaranteed price reimbursement for the vehicle (e.g., the CPO vehicle) 136B from the appraiser computer 124. In this way, the dealer systems 130 may be guaranteed a price for their vehicles 136A and 136B for the swap.

In some exemplary embodiments, the appraiser system 120 may arbitrate the swap transaction between the dealer systems 130. That is, information related to the vehicle swap would (e.g., would only) be exchanged between the appraiser system 120 and the respective dealer systems 130. The appraiser system 120 may also arrange for pickup, delivery and/or transfer of the vehicles identified for swapping.

In other exemplary embodiments, the interaction of the appraiser system 120 may be to provide the dealer system 130A with contact information of one or more other dealer systems 130B and to provide guaranteed prices for the vehicle 136A of the dealer system 130A and for the vehicle 136B of the dealer system 130B to facilitate the swap transaction.

Although the appraiser service is illustrated as used by the dealers, it is contemplated that local appraisal services (for example, local to one or more markets or regions) may use the appraiser system 120 (as, for example, a national appraisal service) for pricing guarantees and/or for comparisons of prices in other market not tracked by the local appraisal service.

In some exemplary embodiments, it is contemplated that the appraiser service may provide different sets of services. For example, the appraiser service: (1) may provide a price guarantee for a CPO vehicle; (2) may facilitate a swap transaction; or may provided both the price guarantee and facilitate the swap transaction.

In some exemplary embodiments, the appraiser system 120 may provide different services to different dealer systems 130 based in the dealers' membership agreement with the appraiser system 120. For instance, the dealer system 130A may pay for a higher membership level than another dealer system 130B and may receive more contact information or contact information of a wider range or type of vehicles. In some exemplary embodiments, the membership levels may be predetermined and the appraiser computer 124 may automatically forward the contact information to a particular dealer based on its predetermined level. For example, the dealer system 130A may receive information for all vehicles or some vehicles based on the vehicle type (e.g., whether the vehicle is a passenger car, a sport-utility vehicle, a truck or a commercial vehicle, among others), the make (e.g., a Ford, a Chevrolet, or a Honda, among others) or any other vehicle information.

Alternatively or additionally, the vehicles 136A and 136B available for swapping may be posted on an online registry (published as a web page by the appraiser computer 124) or bulletin board that is accessible by member dealer systems 130 (e.g., all member dealers) over a network. The member dealer systems 130 in the service may be authenticated using a password by the appraiser computer via their browser or other software to view the registry or the bulletin board. However, the member dealer systems 130 may have limited access to the contact information associated with the listed vehicles based on the dealers' respective membership levels. In this way, an individual member dealer system 130A may be motivated to increase its membership level in the appraiser service to obtain access to additional sales leads that the member dealer system 130A becomes aware of via the registry or the bulletin board.

It is also contemplated that viewing of listed vehicles without contact information in the vehicle registry may be enabled for all interested dealers and consumers (e.g., with or without membership) to promote the appraisal service and to draw new memberships.

After the dealer systems 130A and 130B have agreed to swap the CPO vehicle 136A and the CPO vehicle 136B, respectively, the vehicle 136A may be delivered to the dealer system 130B and the vehicle 136B may be delivered to the dealer system 130A. Each dealer system 130A and 130B may inspect the received vehicle 136B and 136A, respectively, and may compare the inspection results to the vehicle information provided from the other dealer systems 130B and 130A by the appraiser system 120. For instance, the inspection results by the dealer system 130B may note that the vehicle 136A has a misaligned right-rear door. In such a case, the dealer system 130B may confirm that the dealer system 130A disclosed this damage in the vehicle information (e.g., vehicle information checklist) provided to the appraiser computer 124. If, however, the inspection results (or inspection checklist) prove that the vehicle information is inaccurate, the appraiser system 120 may compensate the dealer system 130B for an error or an omission by the dealer system 130A. In some cases, the damage may be evidence that vehicle 136A may have been in a serious collision, which may exclude the vehicle 136A from the CPO certification. In such a case, the swap may be voided or voidable by the appraiser system 120 or the dealer system 130B according to, for example, the terms of the membership agreement. In other cases, the dealer system 130B or the appraiser system 120 may update in the database 122 of the computer 124 of the appraiser system 120 the vehicle information previously provided to the appraiser computer 124 using the feedback received from the inspection. That is, the dealer system 130B, for example, may enter the revised or updated vehicle information in a checklist with pertinent backup information such as vehicle images or vehicle diagnostic test results indicating a variation from the certifications provided by the dealer system 130A to the appraiser system 120 for a determination by the appraiser system 120.

In certain exemplary embodiments, the appraiser computer 124 may automatically adjust the payments to the dealer system 130A in accordance with the inspection results provided by the dealer system 130B. In other exemplary embodiments, the appraiser computer 124 may receive the inspection results provided by the dealer system 130B and may display the inspection results on a display (not shown) for review by a system administrator. In such a case, the appraiser computer 124 may automatically adjust the payments to the dealer system 130A in accordance with user input (e.g., approval) by the system administrator.

Based on the updated vehicle information, the appraiser system 120 may issue a reimbursement to the dealer system 130B for the cost difference. The dealer system 130B may receive reimbursement for costs to certify the vehicle if it was below the required CPO condition level. The appraiser system 120 may also charge the dealer system 130A for the cost of the reimbursement and/or certification costs by the dealer system 130B.

To ensure that the member dealer systems 130 using the appraiser service provide compensation for their errors and omissions, the member dealer systems 130 may have to place an amount of money in an escrow account that may be debited in the event the appraiser system 120 reimburses another member dealer system 130. That is, the escrow account may be charged for the cost difference due to errors or omissions in vehicle information, sub-par certification and, in some cases, may also be charged a penalty fee.

In certain exemplary embodiments, the escrow account may be used as a financial account for transactions between the appraiser system 120 and a particular member dealer system 130.

In certain exemplary embodiments, the appraiser system 120 may provide inspection services at the buyer dealer's system 130B or the seller dealer's system 130A location. The inspection services may ensure that the vehicles 136 meet or exceed CPO certification standards including any regulatory requirement and requirements for CPO warrantees of the vehicles 136.

Each state or geographic region may have different certification requirements due to state or regional differences. As a result, the certification of a vehicle being swapped should meet the local, regional, or state standards of the buyer dealer system 130B. The appraiser computer 124 may publish or communicate these differences to member dealer systems 130 outside the applicable area. In certain exemplary embodiments, the seller dealer system 130A may restrict or limit a swap to a particular region to take advantage of the difference in a regional certification standard. In such instances, the seller dealer may provide the particular region or regions in a transaction request to the appraiser computer 124 and the appraiser computer 124 or database 122 may filter the query of available CPO vehicles based on the particular region or regions.

In certain exemplary embodiments, an appeal process may be implemented to enable the computer 134A of the dealer system 130A to send additional inspection and/or vehicle information to dispute the findings of (information provided by) the dealer system 130B. The appeal process may include the appraisal computer 124 automatically (e.g., without user intervention) sending a notification message to the dealer computer 134A and receiving the additional inspection and/or vehicle information. The system administrator or an expert system may judge whether to reimburse the dealer system 130B and the amount of such a reimbursement based on the change in the CPO vehicle's market value and any other cost and/or penalties that may be imposed by the appraiser system 120.

Exemplary embodiments consistent with the description above allow the swapping of vehicles 136 in which there is no haggling over the vehicles' prices between dealer systems 130. That is, the price of the vehicle 136 may be determined by the appraiser computer 124—not by the dealer systems 130A and 130B. The appraiser system 120 may set and in some embodiments guarantee the price of the vehicles 136A and 136B. In a case where there is a discrepancy between the vehicle condition reported by the seller dealer system 130A and the vehicle condition reported by the buyer dealer system 130B, the appraiser system 120 may adjust the guaranteed price for the discrepancy. Thus, there is little risk or cost for dealer systems 130 in swapping CPO vehicles 136.

Although the system 100 illustrates a system having only an appraiser system 120 and two dealer systems 130, each communicating over a single communication link using a dealer computer 134 (a data processing device), it is contemplated that other arrangements are possible including any number of dealers and computers that communicate over a variety of communication links and networks.

Although a two-way swap is illustrated, it is contemplated that the dealer systems 130 may implement an N-way (e.g., multi-way swap) of vehicles from members of the appraiser service. Such a swap may be implemented as a single swap transaction or may be implemented as N−1 two-way swap transactions in which N is an integer number corresponding to the number of vehicles being swapped.

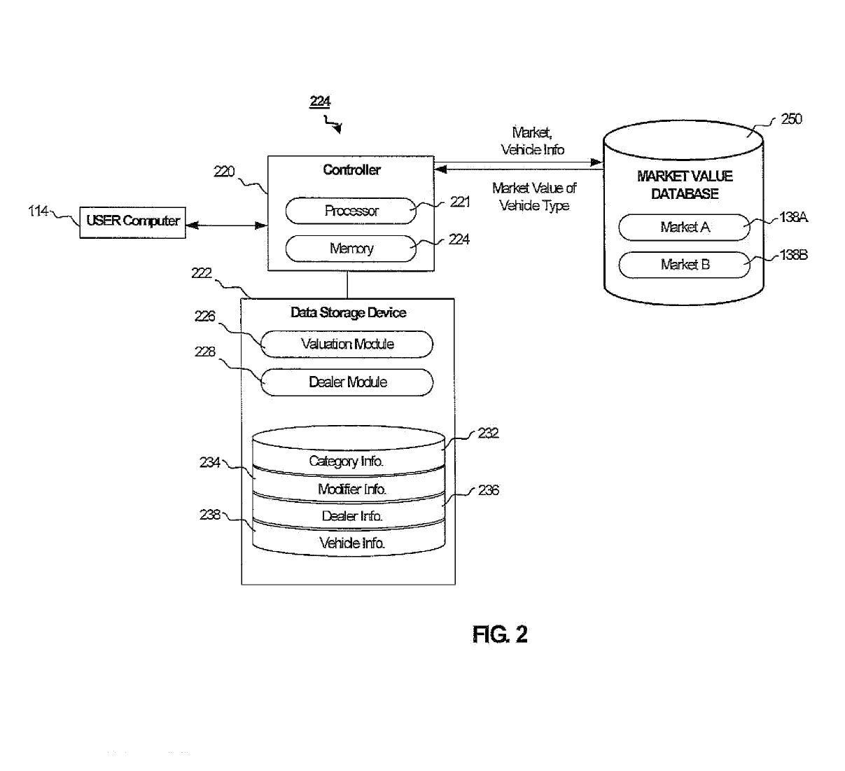

FIG. 2 is a block diagram of an exemplary appraiser computer 224 having a controller (e.g., a microprocessor) 220 communicatively linked to a data storage device 222 and a market value database 250. The appraiser computer 224 may be one or more devices or systems for receiving, storing, displaying, and/or processing user information (vehicle information and swap transaction information), and for providing guaranteed prices for vehicles. The appraiser computer 224 can be implemented as one or more computer systems including, for example, a mobile computer, a smart phone, a personal computer, a minicomputer, a microprocessor, a workstation, a mainframe or a similar computing platform, among other.

The controller 220 may include, for example, a hardware processor or a microprocessor 221 and a memory or data storage device 222, in addition to other components, such as a clock, one or more communication interfaces, a data bus, one or more input/output devices and a display device (not shown). The hardware processor 222 may be a general-purpose processor (e.g., INTEL), or a specialized, embedded processor (e.g., ARM) executing instructions stored in a memory device 224. The memory device 224 may be a random access memory (“RAM”), a read-only memory (“ROM”), a FLASH memory, or the like.

The appraiser computer 224 may store the computer-executable instructions (e.g., software, firmware, applications, programs, modules, code, portions of code, or combinations thereof). Information in the data storage device 222 that, when retrieved and executed by the controller 220, may configure the appraiser computer 224 as a special-purpose machine that may perform the functions described herein. The computer-executable instructions can be encoded using any suitable computer programming language (e.g., XML, C++ or JAVA, among others). The data may be organized in one or more databases allowing the data to be stored, organized, referenced and selectively retrieved. The databases may be organized in a flat-file, relational or multidimensional structure.

The data storage device 222 may be, for example, a magnetic disk drive, an optical disk drive, a flash memory or another device capable of storing non-transitory computer-readable information. As shown in FIG. 2, the data storage device 222 may store computer-readable program instructions for a valuation module 226 and a dealer module 228.

In certain exemplary embodiments, the data storage device 222 may store one or more databases 232-238 including, for example, vehicle category information 232, modifier information 234, dealer information 236 and vehicle information 238. Other configurations of such databases are possible including a single relational database.

The valuation module 226, when executed by the processor 221, may determine a guaranteed price for the vehicles 136. The valuation module 226 may generate a computer-user interface (e.g., on the dealer computer 136A of a respective dealer system 130A) and may perform the interactive interview with the respective dealer system 130A to collect contact information and information associated with the vehicle 136. The interview may be performed consistent with that described in International Application No. WO 01/71458 A2, for example. The received vehicle information 238 may be stored in the data storage device 222.

Based on the vehicle information received from the dealer computers 134 and stored in the data storage device 222, the valuation module 226 may query the market value database 250 to retrieve market values. The market value database 250 may store a set (e.g., a limited set below a threshold number) of information corresponding to a type of vehicle rather than a particular vehicle. For example, the market value database 250 may store values corresponding to a make, a model, options, mileage and/or general condition of the vehicle (e.g., clean, average or rough) that may be submitted to the database 250 from a dealer system 130. The value can apply to thousands of vehicles meeting these descriptors. As such, the market value may represent a value for a vehicle type in a particular market 138A or 138B. In response, the database 250 can provide an estimated value based on the type of vehicle having corresponding mileage, options and vehicle condition. The valuation module 226 may record a guaranteed price for the CPO vehicles 136 along with the respective vehicle condition information.

In certain exemplary embodiments, the valuation model may be updated by the actual sale price of particular CPO vehicles from member dealers associated with the appraisal service. For example, responsive to the sale of a CPO vehicle 136 by a dealer system 130, the dealer system 130 may provide sales information to the appraiser system 120 as part of the member agreement via a sales completion message or a sales completion web page. The appraiser system 120 may use the actual sales information to determine whether to adjust the valuation model regarding the type of vehicle actually sold.

The dealer module 228 may include program instructions and data that, when executed by the processor 221, may control the appraiser computer 224 to exchange information with the dealer computers 134. The dealer module 228 may retrieve dealer information 236 stored in the data storage device 222. Based on the dealer information 236, the appraiser computer 224 may provide contact information to the dealer system 130 and/or the dealer computer 134. For instance, based on the dealer information 236, the appraiser computer 224 may determine whether the dealer system 130A should receive contact information. The appraiser computer 224 may also determine whether to provide the contact information to the dealer system 130A or the dealer computer 134A based on the vehicle information 238 and/or the dealer information 236.

Category information 232 may include a set of predefined or user defined vehicle categories. The vehicle categories may be selected based on a subset of the vehicle information. For instance, a particular color of a vehicle may have a substantial affect on the value of the vehicle 136. In some exemplary embodiments, the categories may be defined by a vehicle's year, make, model and/or color. Other combinations of vehicle information may be used to define categories, as well.

The different categories may have corresponding vehicle information, such as the vehicle identification number (VIN), the make, the model, the year, the exterior color and/or the interior color, among others. Using the corresponding vehicle information, the appraiser computer 224 may select a category corresponding to, for example, the vehicle 136A. The categories may be associated with “category adjustment” information that may be used to modify the value of the vehicles belonging to that category to generate a base value for a vehicle type. The category adjustment may be a single value, a set of values or an algorithm for determining a value. The category adjustment may be stored directly in a category dataset or the dataset could reference the information stored in another location within the data storage device 222. If the category adjustment is an algorithm, the category adjustment may be determined by one or more portions of the vehicle information. For instance, the category adjustment algorithm may determine a curve that relates the adjustment value to a vehicle's year, color and/or mileage.

In some cases, a “category adjustment” may be used to modify the market value of the vehicles retrieved by the valuation module 226 from the market value database 250. For instance, the guaranteed price set by the appraiser computer 224 may account for a vehicle having a particular year, make, model and trim in which a particular color combination has a greater value than a similar vehicle having a less desirable color combination.

Alternatively or additionally, a selected category may include values that affect the modifier information 234 retrieved based on the condition information and history information of vehicle information 238 stored in the data storage device 222. By altering the modifier values based on the category information 232, the guaranteed price set by the controller 220 of the appraiser computer 224 may account for the value of a particular vehicle (e.g., of a make, model, and trim) being affected more or less based on the condition information and/or the history information. For instance, a dent in a driver's side door may have a greater affect on the value of a top-of-the-line luxury automobile than the same damage would on an economy car.

The modifier information 234 may be a set of data that modifies the base value of a vehicle type based on the condition information and/or the history information provided from user computer 114 or a dealer computer 134 of the dealer system 130 and stored in the vehicle Information 238. The condition information may include wear and/or damage to the vehicle 136. For instance, mechanical conditions (e.g., associated with: (1) the frame, (2) the engine, (3) the transmission, (4) the suspension, (5) the brakes, and/or (6) the wheels, among others) and cosmetic conditions (e.g., associated with: (i) scratches, (ii) dents, (iii) dings, (iv) cracks, (v) tears, (vi) scrapes, (vii) burns, and/or odors, among others). In the case of the vehicle being an automobile, the vehicle condition information may include the condition of features such as mileage, bumpers, exterior body, windshields, tires, seats, door panels, a dashboard and/or a frame. The history information may include a vehicle's maintenance and accident history (e.g., proof of regular maintenance, warranty, recalls, accidents and/or insurance claims, among others.)

The vehicle information collected about (or associated with) a vehicle's condition and history may be specific. For example, in the case of a scratch, the valuation module 226 may request information about the scratch location, size, depth and/or any attempted repair of the scratch. For example, the appraisal computer 224 may send a message to the seller dealer system 130 to complete additional input checklists or input screens that provide the requested information. Further, the appraiser computer 224 may inquire about any after-market options or modifications. Using the vehicle information including the additional information requested by the valuation model 226 and received from the user computer 114, the valuation module 226 may retrieve corresponding modifier information 234 from the data storage device 222. For instance, for each scratch the dealer system 130 reports that is on the vehicle 136, an adjustment value may be retrieved from the modifier information 234. The adjustment value (deduction or addition) received may be increased or decreased based on the selected category adjustment for the vehicle 136.

The modifier information 234 may be associated with a maximum modifier threshold that may limit the total modification of the base value. The threshold may be a flat amount or the threshold may represent a percentage of the base value. For example, the valuation module 226 may retrieve a modifier value from the stored modifier information 234 that reduces or increases the value of the vehicle 136 by a certain amount based on conditions (e.g., decrease by an amount, if a passenger had smoked in the vehicle 136). The amount may be adjusted (increase) for each incidence (e.g., of smoking) or by a fixed amount (for such smoking). However, based on the associated threshold value, the base value may not be reduced by more than, for example, a range of about 20% to about 40%, and possibly 30%.

The dealer information 236 may include records corresponding to the dealers, such as the dealer systems 130, which are members of appraiser system 120's service. The dealer information 236 may include a member type, a vehicle type, a market type, a location and/or a point of contact, among others. The member type may describe the type of membership that the dealer has been granted for the appraiser service. The member type may indicate to the dealer module 228 which contact information that is collected by the valuation module 226 may be provided to different dealer systems 130. For instance, a type-I membership may receive contact information for any user that may be provided to the appraiser computer 224. A type-II member may receive less contact information than a type-I member depending on the dealer information and/or the contact information. A type-III member may receive no contact information. In some exemplary embodiments, the type-II member may receive contact information based on users located within a certain range of a dealership, maker type and/or vehicle type.

The market value database 250 may be a searchable database of vehicle values within (e.g., segmented or parsed by) a number of different or overlapping markets 138A and 138B. The market value database 250 may be a part of the appraiser computer 224. In other exemplary embodiments, the market value database 250 can be generated and maintained by a third party provider. The market value database 250 may store a library of vehicle market values corresponding to different markets, such as markets 138A and 138B. Given some vehicle description information, the market value database 250 may provide a current market value for the corresponding vehicle. The market information may be retrieved in response in a query to the market value database 250. The query result may be a market value for a vehicle that exactly matches or most closely matches the vehicle type identified in the query. For instance, the information in the market value database 250 may be accessible by the VIN or simply by designated description information, such as by year, make, model, body type and/or trim level.

The market value received from the market value database 250 may be modified by one or more pieces of the vehicle information. In some exemplary embodiments, for example, the appraiser system 120 and/or the appraiser computer 224 may refine the market value based on a vehicle's mileage, general conditions and/or location. Using this additional vehicle information, the market value can be adjusted (e.g., increased or decreased) to provide a more accurate market value for the type of vehicle identified in the query.

The information and functions of the market value database 250 and the modifier information 234 may be combined into a single database of information. Using the modifier information 234, the market value database 250 can provide the modifier values that can be used to refine the market value of a vehicle type based on a particular vehicle's condition information and its history information. When combined with the category information 232 selected for the vehicle 136, the appraiser computer 224 may generate a guaranteed price for that particular vehicle.

In some exemplary embodiments, the market value database 250 may be included in the appraiser computer 224 and may be maintained by the appraiser system 120. In other exemplary embodiments, the market value database 250 may be located apart from (or remote from) the appraiser computer 224 and/or may be maintained by an independent entity. The market value database 250 may aggregate information from a number of different market databases that may be maintained by the appraiser system 120 as well as different entities.

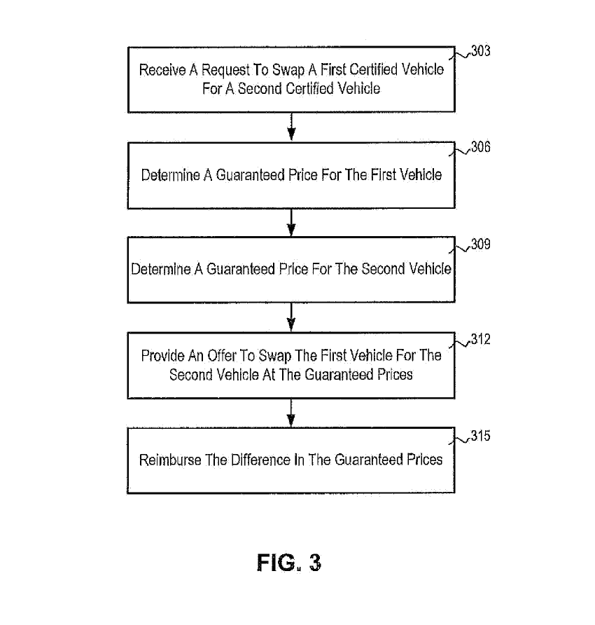

FIG. 3 is a flow chart illustrating exemplary steps for swapping vehicles that may be performed by the appraiser computer 124 or 224. The appraiser computer 124 or 224 may receive a request from the dealer system 130A to swap its vehicle 136A for the vehicle 136B. (Step 303) The dealer system 130A may identify the vehicle 130B based on dealer information provided by the appraiser computer 124 or 224. In some cases, the appraiser computer 124 or 224 may have automatically sent the dealer system 130A information based on its membership information. In other cases, the dealer system 130A may have browsed a registry provided by the appraiser computer 124 or 224 from which the dealer system 130A may identify the vehicle 136B and/or the dealer system 130B for a swap.

In certain exemplary embodiments, the vehicles 136 to be swapped may be CPO vehicles that are certified to satisfy a predetermined standard established by a certification organization, although new and used vehicles swaps are also possible.

The appraiser computer 124 or 224 may determine a guaranteed price for the vehicle 136A offered by the dealer system 130A based on the vehicle information of the vehicle 136A and the market information for the dealer system 130B. (Step 306) The appraiser computer 124 or 224 may determine a guaranteed price for the vehicle 136B offered by the dealer system 130B based on the vehicle information and the market information for the dealer system 130A. (Step 309) For example, the determination, by the appraiser computer 124 or 224 may use stored market values to generate a first guaranteed price of a first vehicle 136A that may be in accordance with the location of the second vehicle 136B and a second guaranteed price of the second vehicle 136B in accordance with the location of the first vehicle 136A.

In certain exemplary embodiments, the determining of the first guaranteed price of the first CPO vehicle 136A may include: (1) establishing the location of the second CPO vehicle 136B; (2) determining of the market price of the first CPO vehicle 136A using the established location of the second CPO vehicle 136B, and (3) setting the first guaranteed price of the first CPO vehicle 136A based on the market price of the first CPO vehicle 136A. Similarly, the determining of the second guaranteed price of the second CPO vehicle 136B may include: (1) establishing the location of the first CPO vehicle 136A, (2) determining the market price of the second CPO vehicle using the established location of the first CPO vehicle 136A, and (3) setting the second guaranteed price of the second CPO vehicle 136B based on the market price of the second CPO vehicle 136A.

The vehicle information may include description information, condition information and history information. The dealer systems 130 may provide the information to the appraiser computer 124 or 224 through dealer computers 134. An interactive user interfaces provided by the appraiser computer 124 or 224 at user computer 114 may prompt the dealer systems 130 to input the vehicle information. For example, to obtain the vehicle 136A's condition information, the dealer interface may request that the dealer system 130A specify the condition of the exterior body of the vehicle 136A by identifying a number of dents, dings, and/or scratches in respective panels of the exterior body of the vehicle 136A. Similar prompts from the valuation module 226 may request details about the vehicle 136A's mechanical and operational condition. Likewise, the valuation module 226 may request specific details about the maintenance, upkeep and/or repairs performed on the vehicle 136A.

In some exemplary embodiments, the user interface provided by the appraiser computer 124 or 224 using the valuation module 226 may be consistent with that disclosed in International Application No. WO 01/71458 A2, the disclosure of which is incorporated herein by reference in its entirety.

In some exemplary embodiments, the appraiser computer 124 or 224 may, at the time, the dealer computer 134A accesses the listing for vehicles available for swapping (e.g., vehicle 136B), determine a guaranteed price for the vehicle 136B based on the vehicle information of the vehicle 136B and the market information of the dealer system 130A. The appraiser computer 124 or 224 may also determine a guaranteed price for the vehicle 136A based on its respective vehicle information and the market information of the dealer system 130B. The guaranteed prices may be presented to the dealer system 130A on the dealer computer 134A together. The appraisal computer 124 or 224 may further provide (establish) related information, such as the difference in guaranteed prices (which is the amount that would be reimbursed to one of the dealer systems 130A or 130B) and other transactions information (e.g., estimated transport fees, taxes, and/or registration fees, among others).

The appraisal computer 124 or 224 may provide the offer to swap the vehicle 136A for the vehicle 136B to the dealer system 130B at the guaranteed prices. (Step 312) In some exemplary embodiments, the guaranteed prices are given (e.g., only given) to the dealer system 130A so that the dealer system 130A can consider the deal before it is offered to the dealer system 130B. For example, if the dealer system 130A believes the guaranteed price of the vehicle 136A is too low (e.g., below a threshold value), the guaranteed price of the vehicle 136B is too high (e.g., exceeds a second threshold value) or a difference in the price between the vehicles 136A and 136B is too great (e.g., exceeds a third threshold value), the dealer system 130A may chose not to pursue the swap. In the event the dealer system 130B accepts an offer to swap, the appraiser computer 124 or 224 may reimburse the difference in the vehicle values to one of the dealer systems 130A or 130B. (Step 315)

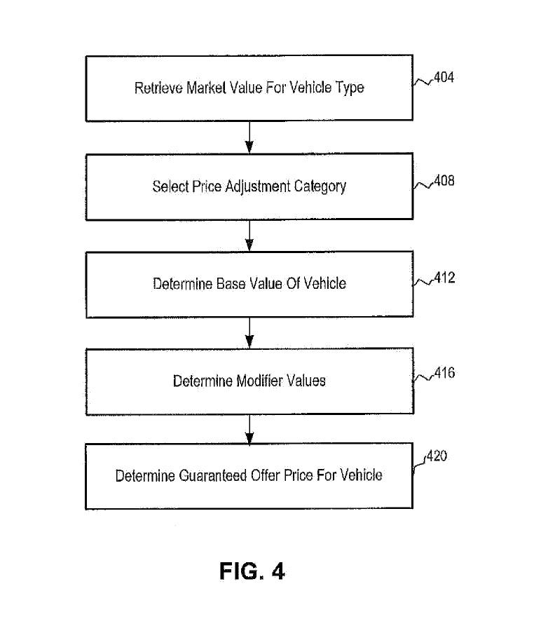

FIG. 4 is a flow chart illustrating exemplary steps for determining a guaranteed price of the vehicles 136. Using the vehicle description information, the valuation module 226 may retrieve a market value for the vehicle type from the market value database 250. (Step 404) The initial market value may be, for example, a value of an “ideal vehicle” of a type that is provided from a database of prices based on, for example, the VIN, the year, the make and/or the model of the vehicle 136.

The valuation module 226 may select a price adjustment category for the vehicle 136. (Step 408) The category may be selected from a predefined set of the category information 232 stored in the data storage device 222. Using the selected price adjustment category, a base value that may be determined from the price of the ideal vehicle of that type. (Step 412)

The modifier values may be retrieved from the modifier information 234 based on the received condition information and the history information stored in received vehicle information 238. (Step 416.) The modifier values may be price adjustments (e.g., incremental values—additions or subtractions) retrieved from the modifier information 234 stored in a database or table of the data storage device 222. These additions or subtractions from the base value for the vehicle 136 may be capped to a predetermined or set threshold value. This threshold may be, in some cases, a flat amount or may be limited to a certain percentage of the base value of the vehicle 136.

For example, the base value of the vehicle 136 may be changed using a modifier value based on (or for) the vehicle's current mileage. The actual mileage, as opposed to a range of mileage, may be used to calculate or to adjust the vehicle 136's value. The modifier information 234 may include a reduction rate (e.g., a depreciation curve or algorithm) for mileage that may be reduced (or capped) after a certain amount of miles have been calculated in relation to the base value for the vehicle 136.

In certain exemplary embodiments, the deduction for mileage may be reduced before fifty percent of the vehicle 136's value is diminished. When adding a value to the base value of the vehicle 136 for low mileage, a different rate may add back half the value for low miles in the same fashion that a deduction may be made for high mileage. For example, once approximately forty percent of the base value has been added for low mile of the vehicle 136, no additional value for lower mileage may be added to increase the base value of the vehicle. That is, the valuation module 226 may limit the adjustment of the base value for low mileage vehicles that are below a first mileage threshold based on the vehicle information (e.g., the vehicle's make, model, and/or year). The valuation module 226 may also limit the adjustment of the base value for high mileage vehicles that are above a second mileage threshold based on the vehicle information.

Each modifier value can be adjusted for a particular vehicle, such as the vehicle 136, based on information stored in the modifier information 234 and associated with the selected adjustment category. For example, with regard to mileage, an adjustment category may have a set of values to calculate the affect that mileage has on a specific vehicle type. The adjustment to a modifier value, corresponding to a selected category, may be based on a flat amount, a set of amounts, a scaling factor or an algorithm that varies with respect to the modifier value. For instance, the category information 232 stored in a database or table of the data storage device 222 may indicate that each deduction for a paint scratch is increased by twenty percent for vehicles in a particular category. Other modifier values for the same vehicle category may not be affected.

Using the base value and the modifier values, the valuation module 226 may determine a guaranteed price for the vehicles 136 (step 420), which may be provided to the dealer system 130. As described above, the dealer module 228 may control the appraiser computer 124 or 224 to provide received contact information to one or more member dealers, such as dealer system 130, based on the dealer information 236 retrieved from the data storage device 222. The dealer information 236 may identify the member dealer systems 130 as belongs to corresponding categories and the contact information 240 may be filtered or parsed based on membership type or participation category, and then the filtered contact information may be provided to particular dealers based on the dealers' respective participation category.

The guaranteed price may be stored in association with a complete summary of the condition of the vehicle as provided by the seller dealer system 130A. The summary may include, for example, the vehicle's 136 VIN, year, make, model, exterior color, interior color, OEM options, exterior flaws, tire condition, wheel condition, interior flaws, frame damage report and/or value. The information provided on the offer certificate may be verified to be accurate for the vehicle 136 by inspection by the appraiser system 120 or after transfer to the buyer dealer system 130B. As such, the dealer system 130B may accept the offer certificate as a payment of value, and the dealer system 130A may provide the certificate to the dealer system 130B as part of the vehicle transaction.

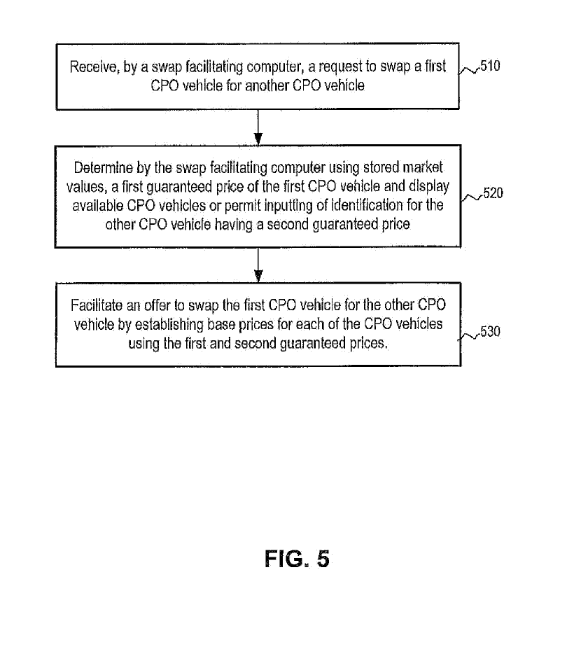

FIG. 5 is a flow chart illustrating exemplary steps for facilitating an offer to swap the vehicles 136. The appraiser computer 124 or 224 (e.g., a swap facilitating computer) may receive a request from dealer computer 134A to swap a first CPO vehicle 136A for another CPO vehicle 136B (Step 510). The swap facilitating computer 124 or 224 using stored market values from the database or table of the data storage device 122 or 222 may determine a first guaranteed price of the first CPO vehicle 136A and may display available CPO vehicles 136B (e.g., from the registry) or may permitting input of identification (criteria such as vehicle identifiers including make, model, price and/or color, among others) for the other CPO vehicle 136B having a second guaranteed price. (Step 520)

In certain exemplary embodiments, the swap facilitating computer 124 or 224 may query for available CPO vehicles based on the criteria inputted and return to a dealer computer 130 a list of choices for the swap. The list may include a sort order based on: (1) the distance of the available vehicle to the dealer's location; (2) the guaranteed price of the available CPO vehicle 136B; or (3) the feedback rating of the dealer associated with the available CPO vehicle 136B.

The swap facilitating computer 124 or 224 may facilitate an offer to swap the first CPO vehicle 136A for the available (e.g., other) CPO vehicle 136B by establishing base prices for each of the CPO vehicles 136A and 136B using the first and second guaranteed prices. (Step 530).

In certain exemplary embodiments, the appraiser (e.g., swap facilitator) computer 124 or 224 may receive an information request from, for example a dealer system 130 or the dealer's computer 134, to provide information associated with the CPO vehicles available to be swapped. In response to the information request, the appraiser computer 124 or 224 may retrieve and send, a list of the registered CPO vehicles available to be swapped.

In certain exemplary embodiments, the appraiser computer 124 or 224 or the data storage device 222 may filter the list of registered CPO vehicles, prior to sending the list based on criteria included in the information request. The criteria may include, for example: (1) the level or type of service (e.g., a premium or standard service) purchased by the dealer system 130A requesting the list; and/or (2) the vehicle information and/or the condition information identified in the information request. It is also contemplated that the data storage device 222 may filter the list of registered CPO vehicles based on the level or type of service (e.g., a premium or standard service) purchased by the dealer system 130B having the vehicle 136 available for swapping.

In certain exemplary embodiments, in the event that the buyer dealer system 130B (e.g., the dealer receiving the swapped vehicle 136A) determines that the vehicle 136A that had been swapped does not comply with vehicle information provided by the seller dealer system 130A, the buying dealer system 130B may send to the appraiser computer 124 or 224, updated vehicle information of the vehicle 136A that had been swapped. The appraiser computer 124 or 224 may then determine a revised guaranteed price of the vehicle 136A based on the updated vehicle information of the vehicle 136A. The appraiser system 120 may reimburse the buyer dealer system 130B based on the revised guaranteed price.

In certain exemplary embodiments, the determination of the guaranteed price for the first and second CPO vehicles 136A and 136B may include the appraiser computer 124 or 224: (1) receiving from a first entity, first evaluation information for determining a first value associated with the first CPO vehicle 136A; (2) receiving from a second entity 130B, second evaluation information for determining a second value associated with the second CPO vehicle 136B; (3) selecting a price adjustment category for each respective CPO vehicle 136A or 136B from a set of price adjustment categories stored in the data storage device 222 based on the first or second evaluation information associated with the respective CPO vehicle 136A or 136B; (4) determining a base value for each of the first and second CPO vehicles 136A or 136B by modifying the stored market value of a vehicle type based on an amount corresponding to the selected price adjustment category; (5) determining a modifier value based on the vehicle information received from the respective computer 134A or 134B of the first entity or the second entity 130A or 130B by limiting the amount of the modifier value to a threshold value; and (6) determining a guaranteed price for each of the first CPO vehicle 136A and the second CPO vehicle 136B by combining the base value and the modifier value of the respective first and second CPO vehicles 136A and 136B.

In certain exemplary embodiments, the determination of the modifier value may include establishing the modifier value based the vehicle information that describes a condition of a respective CPO vehicle 136A or 136B or a history of the respective CPO vehicle 136A or 136B.

In certain exemplary embodiments, the selection of the price adjustment category may be based on the first and second CPO vehicles 136A or 136B, a make of one or both of the CPO vehicles 136A or 136B, a model of one or both of the CPO vehicles 136A or 136B and/or a color of one or both of the CPO vehicles 136A or 136B.

In certain exemplary embodiments, the dealer system 130A may belong to a set of participation categories such that the vehicle information of the vehicle 136B may be provided to the dealer system 130A based on a respective one of the participation categories.

The disclosed embodiments allow dealers to swap certified pre-owned vehicles for a guaranteed price determined by a third-party appraiser. A dealer can thereby exchange a vehicle that is not selling for one that is expected to sell while minimizing its opportunity cost and transaction cost of making the swap.

As disclosed herein, embodiments and features can be implemented through computer hardware and/or software. Such embodiments can be implemented in various environments, such as networked and computing-based environments with one or more users. The disclosed embodiments, however, are not limited to such examples, and the embodiments can be implemented with other platforms and in other environments.

Other embodiments of the invention will be apparent to those skilled in the art from consideration of the specification and practice of the embodiments disclosed herein. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A computer-implemented method for swapping certified pre-owned (CPO) vehicles, the CPO vehicles being certified to satisfy a standard established by a certification organization, comprising:
receiving, by a swap facilitating computer, a request to swap a first CPO vehicle for another CPO vehicle;
determining, by the swap facilitating computer using stored market values, a first base price of the first CPO vehicle and displaying available CPO vehicles or permitting inputting of identification for the other CPO vehicle having a second base price; and
facilitating an offer to swap the first CPO vehicle for the other CPO vehicle by establishing base prices for each of the CPO vehicles using the first and second guaranteed prices.

2. The method of claim 1, wherein the first base price and the second base price are guaranteed prices.

3. The method of claim 2, wherein the price of each vehicle in the offer to swap is established, by first and second dealers, with the guaranteed first and second prices establishing the base prices.

4. The method of claim 1, further comprising determining, by the swap facilitating computer using stored market values, the second base price of the other CPO vehicle.

5. The method of claim 4, wherein:
the determining of the first base price of the first CPO vehicle includes establishing the first base price in accordance with a location of the other CPO vehicle; and
the determining of the second base price of the other CPO vehicle includes establishing the second base price in accordance with a location of the first CPO vehicle.

6. The method of claim 5, wherein:
the determining of the first base price of the first CPO vehicle includes:
establishing the market of the first CPO vehicle,
determining the market price of the first CPO vehicle using the location of the other CPO vehicle, and
setting the first base price of the first CPO vehicle based on the market price of the first CPO vehicle; and
the determining of second base price of the other CPO vehicle includes:
establishing the market of the other CPO vehicle,
determining the market price of the other CPO vehicle using the location of the first CPO vehicle, and
setting the second base price of the other CPO vehicle based on the market price of the other CPO vehicle.

7. The method of claim 1, wherein:
the request is initiated by a first entity;
the other CPO vehicle is under control of a second entity; and
the first and second base prices are guaranteed by a third entity, different from the first and second entities.

8. The method of claim 7, wherein the first and second entities are dealers.

9. The method of claim 1, further comprising registering, in a storage device associated with the swap facilitating computer, CPO vehicles available to be swapped.

10. The method of claim 9, further comprising:
retrieving and sending, in response to the request, a list of the registered CPO vehicles available to be swapped.

11. The method of claim 10, further comprising:
filtering the list of registered CPO vehicles, prior to sending the list based on criteria included in the information request.

12. The method of claim 1, wherein the permitting of inputting of identification for the other CPO vehicle having a second base price includes inputting of criteria for selection of available CPO vehicles.

13. The method of claim 5, wherein:
the determining of the first base price includes:
calculating the base price of the first vehicle based on information associated with the first CPO vehicle provided by a first dealer computer to the swap facilitating computer, and
the determining of the second base price includes:
calculating the base price of the other CPO vehicle based on information associated with the first CPO vehicle provided by a second dealer computer to the swap facilitating computer.

14. The method of claim 8, wherein in the event that one dealer of the first and second dealers determines that the CPO vehicle that had been swapped to the one dealer does not comply with vehicle information provided by the other dealer, the method further comprises:
receiving updated vehicle information of the CPO vehicle that had been swapped to the one dealer;
determining a revised base price of the CPO vehicle that had been swapped to the one dealer based on the updated vehicle information of the CPO vehicle that had been swapped to the one dealer received from the one dealer; and
reimbursing the one dealer based on the revised base price.

15. The method of claim 14, further comprising charging the other dealer for a reimbursement of the one dealer.

16. The method of claim 15, wherein the charging of the other dealer for the reimbursement includes charging one of: (1) an escrow account of the other dealer for the reimbursement; (2) a credit account of the other dealer for the reimbursement; or (3) a debt account of the other dealer for the reimbursement.

17. The method of claim 1, wherein the determining of the first base price for the first CPO vehicle includes:
receiving, by the swap facilitating computer from a first entity, first evaluation information for determining a first value associated with the first CPO vehicle;
selecting, by the swap facilitating computer, a price adjustment category for the first CPO vehicle from a set of price adjustment categories stored in a data storage device associated with the swap facilitating computer based on the first evaluation information;
determining, by the swap facilitating computer, a base value for the first CPO vehicle by modifying the stored market value of a vehicle type of the first CPO vehicle based on the selected price adjustment category;
determining, by the swap facilitating computer, a modifier value based on the vehicle information received from the first entity; and
determining, by the swap facilitating computer, a base price for the first CPO vehicle by combining the base value and the modifier value of the first CPO vehicle.

18. The method of claim 17, wherein the determining of the modifier value includes establishing the modifier value based the vehicle information that describes a condition of the first CPO vehicle or a history of the first CPO vehicle.

19. The method of claim 18, further comprising establishing a threshold value for the first CPO vehicle as a percentage of the base value such that the threshold value is associated with the modifier value and is a fixed value.

20. The method of claim 17, wherein the selecting of the price adjustment category is based on a make of the first CPO vehicle, a model of the first CPO vehicle and a color of the first CPO vehicle.

21. The method of claim 17, wherein the first entity is a first dealer and a second entity is a second dealer such that the first and second dealers belong to a set of participation categories and the second vehicle information is provided to the first dealer based on the participation category of at least one of the first and second dealers.

22. A system for swapping certified pre-owned (CPO) vehicles between first and second dealers, comprising:
a database of market values;
a swap facilitating computer including a processor and a data storage device, the storage device storing instructions that, when executed by the processor, control the swap facilitating computer to:
receive a request from the first dealer to swap a first CPO vehicle for another CPO vehicle of the second dealer;
determine using the database of market values a first base price of the first CPO vehicle;
display available CPO vehicles or permit inputting of identification for the other CPO vehicle having a second base price;
establish base prices for each of the CPO vehicles; and
facilitate an offer to swap the first CPO vehicle for the other CPO vehicle based on the established base prices for the CPO vehicles.

23. The system of claim 22, wherein the first base price and the second base price are guaranteed prices.

24. The system of claim 22, wherein the swap facilitating computer using stored market values determines the second base price of the other CPO vehicle.

25. The system of claim 24, wherein the swap facilitating computer establishes the first base price in accordance with a location of the other CPO vehicle and the second base price in accordance with a location of the first CPO vehicle.

26. The system of claim 25, wherein the swap facilitating computer:
(1) establishes a market of the first CPO vehicle, determines a market price of the first CPO vehicle using the location of the other CPO vehicle, and set the first base price of the first CPO vehicle based on the market price of the first CPO vehicle; and
(2) establishes a market of the other CPO vehicle, determine a market price of the other CPO vehicle using the location of the first CPO vehicle, and setting the second base price of the other CPO vehicle based on the market price of the other CPO vehicle.

27. The system of claim 22, wherein first and second dealers certify that the respective first and second CPO vehicles satisfy a standard condition level established by a certification organization.

28. The system of claim 22, wherein the processor, further controls the swap facilitating computer to pay a difference in the first and second guaranteed prices to one of the dealers.

29. The system of claim 22, wherein:
the first base price of the first CPO vehicle is calculated based on information of the first CPO vehicle provided by the first dealer to the swap facilitating computer, and
the second base price of the other CPO vehicle is calculated based on information of the other CPO vehicle provided by the second dealer to the swap facilitating computer.

30. The system of claim 22, wherein, responsive to vehicle information associated with the first CPO vehicle provided by the first dealer not complying with the vehicle information, further controlling the swap facilitating computer to:
receive updated vehicle information of the first CPO vehicle from the second dealer;
determine the revised base price of the first CPO vehicle based the updated vehicle information of the first CPO vehicle received from the second dealer; and
reimburse the second dealer based on the revised base price.

31. The system of claim 30, wherein a swap facilitating computer charges the first dealer for the reimbursement of the second dealer.

32. The system of claim 30, wherein the swap facilitating computer charges an escrow account of the first dealer for the reimbursement.

33. The system of claim 22, wherein the swap facilitating computer provides a registry of available CPO vehicles to the first dealer that lists the second CPO vehicle.

34. The system of claim 22, wherein the instructions for determining the base prices for the CPO vehicles further include instructions that control the swap facilitating computer to:
select a price adjustment category for each of the CPO vehicles from a set of price adjustment categories stored in the data storage device based on vehicle type information received from another computer;
determine a base value for each of the CPO vehicles by modifying a market value of a vehicle type retrieved from a database based on an amount corresponding to the selected price adjustment category;
determine a modifier value based on vehicle information received from a respective dealer computers, the swap facilitating computer limiting an amount of the modifier value to a threshold value; and
determine a guaranteed price for each of the CPO vehicles by combining a respective base value with a corresponding modifier value.

35. The system of claim 34, further comprising a user computer sending information describing a condition of the first CPO vehicle or a history of the first CPO vehicle, wherein the modifier value determined by the swap facilitating computer that is associated with the first CPO is based on the information received from a user computer.

36. A computer-readable storage device storing program instructions that, when executed by a processor, controls a swap facilitating computer to:
receive a request from the first dealer to swap a first CPO vehicle for a second CPO vehicle of the second dealer;
determine using the database of market values corresponding to a market of the second dealer, a first base price for the first CPO vehicle;
determine using the database of market values corresponding to a market of the first dealer, a second base price for the second CPO vehicle; and
provide an offer to the second dealer to swap the first CPO vehicle for the second CPO vehicle at the first and second base prices,
wherein the first and second dealers certify that the respective first and second CPO vehicles satisfy a standard condition level established by a certification organization.
